(19) United States
(12) Patent Application Publication
(10) Pub. No.: US 2025/0354927 A1
(43) Pub. Date: Nov. 20, 2025

(54) SURFACE PLASMON RESONANCE MEASURING SYSTEM AND A METHOD FOR SURFACE PLASMON RESONANCE MEASUREMENT FOR INJECTION OF SAMPLES USING A CUVETTE-INJECTION-FLOW SYSTEM

(71) Applicant: VYSENS B.V., Hengelo (NL)

(72) Inventor: Richard B.M. SCHASFOORT,, Haaksbergen (NL)

(73) Assignee: VYSENS B.V., Hengelo (NL)

(21) Appl. No.: 18/874,139

(22) PCT Filed: Jun. 13, 2023
(86) PCT No.: PCT/EP2023/065798

§ 371 Date: Dec. 12, 2024

Related U.S. Application Data
(60) Provisional application No. 63/351,478, filed on Jun. 13, 2022.

(51) Int. Cl. G01N 21/552; G01N 35/10

(52) U.S. Cl. CPC G01N 21/554; G01N 35/1095; G01N 2035/1062

(57) ABSTRACT

The present invention provides a system and method for a surface plasmon resonance measuring and injection system and to a method for surface plasmon resonance measurement using the so-called cuvette-injection-flow system.

### CROSS REFERENCE TO RELATED APPLICATIONS

This application is the US national application of PCT/EP2023/065798, filed 13 Jun. 2023, which claims benefit of and priority to U.S. Provisional Patent Application No. 63/351,478, filed 13 Jun. 2022, where permissible incorporated by reference in its entirety.

### BACKGROUND

### Field of the Invention

The present invention relates to surface plasmon resonance measuring and injection systems and to a method for surface plasmon resonance measurement using the so-called cuvette-injection-flow system.

### Description of Related Art

Surface Plasmon Resonance is an optoelectronic technique for detecting interactions at a thin metal film. When a Kretschmann configuration is applied polarized light is shone through a prism onto a thin metal film. The angle of incidence can be changed and the intensity of the reflected light is monitored using an optical unit. While scanning the angle of incidence the intensity of the reflected light passes through a minimum due to excitation of surface polaritons. The angle at which maximum loss of the reflected light intensity occurs is called the SPR angle or SPR-dip. The SPR angle is dependent on the refractive index of the medium present on the metal surface and, thus dependent on the accumulation or desorption of molecules such as proteins on the thin metal layer. One can find several configurations of SPR instrument in chapter 3 of the Handbook of Surface Plasmon Resonance 2017 editor R. B. M. Schasfoort, RSC London.

SPR is predominantly used for measuring the change in refractive index in the evanescent field, which phenomenon is generated at a distance very close to the sensor surface. When a (bio) molecular interaction occurs at the sensor surface the change of refractive index can be measured in real-time and label-free.

SPR sensors are generally not selective in relation to the molecular interaction of the target compound. This is because the changes in the surface plasmon resonance angle of light incidence at the sensor surface may be due to differences in the medium, such as the composition and concentration of the buffer, due to absorption of non-target material on the surface, and also to, for instance, the temperature.

Selectivity may be achieved by modifying the sensor surface by binding ligands, which selectively capture the target compound. Common mode effects like temperature differences and bulk changes in the SPR-angle of light incidence at the sensor surface can be compensated by using a channel or spot where specific bio-molecular interactions do not occur. It is preferred that the SPR measurement is carried out while the buffer or sample continuously flows along the sensor surface for reducing mass diffusion relative to the sensor surface. Various fluidic configurations are applied to allow the exposure of the analyte to the ligands bound to the sensor surface. The dominant system is a lateral flow cell with an inlet and outlet connected to sample loops or hydrodynamic isolation principle, address flow principle, open cuvette configuration, back and forth flow system, air-parc system etcetera.

Non-specific binding of non-target compound or components may still take place, thereby it is preferred that the SPR measurement comprises a first association step by continuously flushing the sample solution along the sensor surface, followed by a dissociation step in which buffer solution or another solution is continuously flushed along the sensor surface, thereby dissociating non-target compound while the target compound remains bound to the specific ligands adhered to the sensor surface. If partial dissociation of the target compound also may occur, then correction would be possible by measurement of appropriate reference locations on the same sensor surface.

In an SPR imaging system, a source for polarized light shines via a prism onto the sensor surface while the reflected light is monitored using a camera. When the sensor surface is imaged to the camera it is possible to monitor in real time separate and individual parts of the sensor surface at which the same or different ligands are adhered to the sensor surface. Hereby it becomes possible in real time, and at the same time, to measure for different target compound in one and the same sample.

The sensor surface is provided with a ligand which is generally a biological element, such as a single cell, a microorganism, an organelle, a cell receptor, an enzyme, an antibody, an antigen, protein, DNA, RNA, peptide or other biologically active compound.

The SPR fluidic system should be primed with a solution to prevent air or air bubbles coming into contact with the sensor surface. A sample should be injected instantly in order to create a stepwise exchange of buffer with sample. For fast biomolecular interactions the transition from buffer to sample should be as fast as possible preferably within a second from pure buffer to 100% sample exposure. When the distance of the injection tubing is long then the sample is injected not instantly but slowly. Laminar flow in the tubing will cause mixing of the sample with the buffer to occur during the transport of the sample in the tubing. In injection systems in the market, an air bubble is used to prevent mixing of sample with buffer during transport. Just before injection, the air bubble is parked in a T-connected tubing. Now the sample and buffer will be connected and instantly be injected. Other instruments apply injection loops very close to the sensor surface in order to allow instant air bubble-free injection of the sample. In the 1990s, cuvette-based systems were in the market with injection and drain tubing. The open cuvette was directly pressed onto the sensor surface and mixing was applied using a free wall-jet system or a piston mixer. In the handbook of Surface Plasmon Resonance 1^{st} edition such cuvette systems are described in chapter 3.3.2.

The core of the invention is to apply a so-called cuvette injection flow (CIF) system for an SPR imaging instrument. The cuvette part of the CIF system of the invention can be considered as a controlled microbioreactor. Injection and drain tubing lines connected to the cuvette have beneficial features. This makes it possible to mix the sample, to dilute it in a controlled manner, to incubate, to prereact, to prevent sedimentation using cells, to thermostate the sample before injection, and to create a gradient of ligand densities on the sensor surface in the flow cell part of the system. Other benefits and features are described in this patent application for pretreating the sample before exposure to the sensor surface occurs. E.g. two cuvettes are connected to a single flow cell for creating two continuous ligand density gradients. The core of the invention is characterized in that the distance between cuvette and flow cell is relatively short e.g. a few millimeters with a volume of less than 10 microliters. In this way, instant injection of sample into the flow cell is possible.

The flow cell part of the CIF system of the invention consists generally of a confined space formed in a support, which is applied onto the sensor surface thereby forming the flow cell with an in- and outlet port. The flow cell is connected to a system for aspirating buffer, sample or other relevant liquid such as a regeneration solution. Liquid transport means are also present in order to maintain a flow of liquid over the sensor surface during the measurement. Accordingly, this substantially avoids the possibility that changes in composition, concentration, pH and the like will result in a change in the surface plasmon resonance reflectivity. The measurement not only comprises, as stated above, a first association step followed by a dissociation step. Obviously a pre-accommodation step and/or a last regeneration step may also be included. Generally, under flushing conditions, the measurement may take place during 1 second to 1 day, or preferably 30 seconds to 1 hour, such as 30 seconds to 5 minutes. The measuring time is inter alia dependent on the concentration of the target compound and/or the reactivity of the ligand and the applied flow conditions.

The flow cell may have a flow cell volume ranging from 1 nanoliter to 1 milliliter, such as 10 nanoliter to 1 milliliter, like 100 nanoliter to 500 microliter, like 1-100 microliter dependent on selectivity and sensitivity of the measurement. Surface plasmon resonance (SPR) is the gold standard for detecting in real-time and label-free biomolecular interactions of a specific analyte to a ligand that is immobilized on a sensor in the form of a microchip.

A microarray of spotted ligands can be utilized in different and optimized concentrations for analysis. However, not only the concentration but also affinity/avidity can be implemented on the chip. Such sensor may be used for the comparison and prediction of the status of (pre) clinical, early and established disease.

The CIF system can be used to generate a gradient of ligand density on the sensor surface. After a ligand is injected into the cuvette, either manually by a user or automatically using an autosampler, the ligand solution will be slowly pumped by aspiration and by diffusion into the flow cell. The ligand will bind to the sensor surface (e.g. by pre-activation with EDC/NHS) but because of this slow pumping/diffusion the contact time of the ligand over the sensor surface area will vary. Close to the cuvette injection line, the exposure time is longest. When the ligand solution arrives close to the outlet then the ligand can be pumped back so that a gradient of ligand density will be formed from the beginning (high ligand density) to the end of the flow cell (low or zero ligand density). An important application of label-free sensing instrumentation is the kinetic measurement of on- and off-rates of an analyte that binds to the ligand. This will be explained in the section: The CIF device to determine kinetic parameters using a ligand density gradient. In a special version of the CIF system, two cuvettes are connected to the flow cell. The two cuvettes can be applied to create two different ligand density gradients using a small volume. A larger volume analyte can be injected into the cuvette and the two small cuvettes will be addressed with the same analyte. Now a two-plex biomolecular interaction on two ligand density gradients can be applied in this fluidic CIF configuration.

### SUMMARY OF THE INVENTION

In one aspect, the present invention has for its object to further improve the SPR measurement while maintaining a back and forth flow (which is quasi continuous) at the sensor surface.

In another aspect the present invention has for its object to further improve the SPR measurement while maintaining a substantially continuous flow condition at the sensor surface.

This object of the invention is met by providing a surface plasmon resonance measuring system comprising:
i. at least one sensor having at least one sensor surface;
ii. at least one flow cell which is in liquid contact with the sensor surface in combination with a controlled microbioreactor or dual tubing connected single cuvette;
iii. an optical unit for measuring (the shift in) the surface plasmon resonance angle of light incidence at the sensor surface;
iv. sampling means for supplying at least a sample and a buffer;
V. liquid transport means for liquid transport;
vi. means for generating a back and forth flow of sample or buffer at the sensor surface;
vii. means for creating a gradient in ligand density on the sensor surface; and
viii. means for operating the cuvette with either an injection line or drain line or both.

### BRIEF DESCRIPTION OF THE FIGURES

The invention is hereinafter described in more detail by way of example only, with reference to the attached figures listed below.

FIG. 1. (A) Representation of a Single gradient flow cell; (B) Representation of a Double gradient in single flow cell according to FIG. 7; (C) Representation of a Double gradient flow cell; (D) Representation of a Four channel in criss-cross over a single, double or four channel flow cell; and (E) Representation of a Six channel in interdigitated geometry.

FIG. 2. A schematic presentation of an embodiment of cuvette injection flow system according to the invention; the cuvette is connected to an injection line and a drain line. The cuvette is connected to the entrance of the flow cell by a low volume channel. The sample can be manually injected into the cuvette or by means of an autosampler.

FIG. 3. Schematic shown at a larger scale detail of FIG. 2; the drawing is at the moment of injection including the ligand density gradient.

FIG. 4. Diagram showing the sample in the cuvette. The cuvette is operated with one or two injection or drain lines via distribution valves of the syringe pump. The cuvette is connected to the flow cell by means of a low volume channel. The outlet of the channel (in the back of the drawing) is connected to the syringe pump.

FIG. 5. A perpendicular side view of the cuvette injection flow system. Clearly the cuvette is connected via the low volume channel to the flow cell and the outlet of the flow cell will be connected to the pump. The injection line of the cuvette will be twisted around the device in contact with the thermostated tubing for injecting thermostated sample into the cuvette.

FIG. 6. When cells are injected in the microbioreactor or cuvette the cells will sediment. In order to get the cells in suspension again back and forth flow to the thermostated injection line can be applied. Then the cell suspension can be injected directly into the flow cell without delay. This way of mixing can also be applied to dilute the sample in the cuvette.

FIG. 7. SPR image of injection of the flow cell from the cuvette. Panel A: The sensor surface is exposed to running buffer solution. Panel B: Injection of high refractive index sample in the flow cell. On the right side the resonance conditions are changing during injection. Panel C: Same as shown in Panel B but at a later stage. Panel D: The flow cell is exposed to high refractive index sample. The running buffer is aspirated out of the flow cell. High reflectivity change can be observed.

FIG. 8. An alternative embodiment, in which the cuvette is designed with two additional containers on the bottom with two injection lines to the flow cell/chamber. In this way, two different ligands can be pipetted to the containers and both ligands can be simultaneously aspirated in the flow chamber with the tubing on the backside of the flow chamber in order to generate two different ligand density gradients on the sensor surface. After washing with the injection and drain lines the cuvette can be filled with an analyte that covers both containers and the single analyte will be exposed to both ligands.

### DETAILED DESCRIPTION OF INVENTION

The surface plasmon resonance measuring system according to the invention comprises means for generating a back and forth flow during measurement at the sensor surface, thereby maintaining the flow conditions during measurement. However, due to the back and forth flow the required amount of liquid, in particular the amount of sample and further the amount of buffer and optional regeneration liquid, are kept relatively small. It is important to note that the amount of, in particular, the sample is substantially independent of the time required for carrying out the measurement, because in particular the sample is moved back and forth over the sensor surface. Due to the back and forth movement the transport of target compound from the sample solution towards the sensor surface where the target compound is to bind to the ligand, is substantially independent on the diffusion rate through the stationary liquid film layer on the sensor surface. Furthermore, no transport or injection loops are required and no liquid transportation means comprising valves for otherwise limiting the amount of sample required for doing the SPR measurement.

It is important to note that for a reliable back and forth flow of sample and/or buffer at the sensor surface during the measurement, it is essential that the sample and the buffer are separated by a separation fluidum e.g. an airbubble as indicated in PCT patent application nr. WO 2012/045325. However, the separation fluidium is not necessary when the volume of the channel between flow chamber and cuvette is smaller than the volume of sample injected in the cuvette. In more detail: when the volume of the channel between cuvette and flow chamber plus the volume of the flow chamber is substantially smaller than the injected sample volume then one can achieve a stable injection of the sample. Even a migration of sample or buffer by in-diffusion takes place outside the flow cell in the tubing that is connected to the pump via the flow cell. The injected sample will keep its concentration in the flow cell and will not be diluted by buffer through in-diffusion of buffer into the sample during the measurement time of the sample. When very long exposure times should be applied then also larger sample volumes should be applied to prevent in-diffusion by the buffer, which dilutes the sample that is exposed to the sensor surface.

For a reliable and simple generation of the back and forth flow conditions, it is preferred that the sampling means comprises a tubing or microchannel connected to the flow cell and to the back and forth flow means. Accordingly, the same tubing may be used for generating the back and forth flow of simultaneously the buffer solution and the sample solution. In this respect it is further preferred that the back and forth flow means comprise a back and forth moving actuator, such as a piston or pressure unit. In this way the back and forth flow may be generated using a piston or a pressure unit. Such pressure unit may exercise a pressure on the tubing, thereby generating in the tubing the back and forth flow of sample and buffer.

As stated above, the SPR measurement requires the monitoring of a shift of the SPR angle or shift in reflectivity which corresponds to an increase or decrease of material mass at the sensor surface and/or due to the presence at the sensor surface of a sample, buffer, regeneration liquid. It can be used for calculating a change or shift in the surface plasmon resonance angle of light incidence at the sensor surface. The monitoring may take place with individual optical means, such as photodiode or camera. However, a common camera may be used for imaging the surface plasmon resonance condition at the sensor surface or a plurality of region of interests at the sensor surfaces.

A calibration routine can be applied to calculate reflectivity (% R) to refractive index units (RIU) or times 10⁻⁶ \hat{˜} resonance units (RU) (alternatively termed micro refractive index units (μRIU)). The calibration routine implies concatenated injections of solutions of refractive index buffers e.g. X % upto 10% glycerol in running buffer. In the controlled microbioreactor connected to two lines also a glycerol gradient can be created for the calibration procedure. The dislinearity of the reflectivity curve for the regions of interest of the sensor surface can be fitted to the response of the X % glycerol injections. In this way shifts of reflectivities can be recalculated to shifts in resonance units (RU) or micro refractive index units (μRIU).

As indicated above, the SPR measurement may be sensitive to temperature changes. In order to avoid an influence of temperature on the SPR measurement it is preferred that a thermostatic unit is present for the sample, the buffer, washing, mixing and/or calibration solutions, which will be in contact with the sensor for measurement during the back and forth movement. Such thermostatic unit is suitable for maintaining the temperature of the sample and/or buffer at a constant temperature + or −0.1° C., preferably +/−0.01° C., more preferably less than +/−0.01° C.

In an example of such a thermostatic unit the liquid from the cuvette can be aspirated in the thermostated section that comprises a metal block with a channel structure that can have a specific length of channels or tubing and therefore can hold a specific volume of liquid and that is precisely maintained at a specific temperature. The comprised volume of liquid in the tubing in the thermohead is chosen such that the liquid that enters the cuvette before it will be injected into the flow cell has the same temperature as the liquid in the flow cell. This prevents a bulk shift due to temperature differences of liquids that are exposed to the sensor surface.

Another aspect of the invention relates to a means and method for measuring a (bio) molecular interaction by SPR measurement such as in the SPR measuring system according to the invention, which has been discussed above and is subject of the present invention. This means and method for SPR measurement comprises, according to the invention, the following features:
i. Sampling means for the sample in a cuvette or microbioreactor closely connected via a low volume channel to the flow cell;
ii. The volume of the channel between cuvette and flow cell is typically smaller than the sample volume e.g. between 1 and 20 microliter;
iii. Open cuvette with tubing connected to the bottom of the cuvette to drain (or empty) the cuvette;
iv. Open cuvette or container with an injection line for storage of the sample;
V. Injection line with thermostated storage line enabling injection of thermostated samples from the cuvette into the flow cell;
vi. Injection line for injecting a part of the sample volume to create dilutions of the sample in the cuvette;
vii. Controlled injection of samples in the cuvette via an autosampler for series of injections;
viii. Mixing of sample in the cuvette by means of back and forth flow via the storage line or drain line;
ix. Mixing of particles in a sample or cells in a cultivation medium in the cuvette to prevent sedimentation of the particles or cells before injection into the flow cell.
x. Slow injection of the ligand in the flow cell for creating a gradient of ligand density at the sensor surface;
xi. Optional slow injection of two ligands simultaneously from two small cuvettes connected to the flow cell. The two small cuvettes can be applied to fill with a single analyte.
xii. contacting the sensor surface with the buffer;
xiii. measuring the surface plasmon resonance reflectivity at the sensor surface while in contact with the buffer being in back and forth movement;
xiv. Fast injecting the sample directly from the cuvette into the flowcell without separation fluidum so without an air bubble to separate buffer from the sample;
XV. contacting the sensor surface with the sample in the flowcell;
xvi. measuring the change in the surface plasmon resonance angle of light incidence at the sensor surface while in contact with the sample being in back and forth movement; and optionally the step of:
xvii. passing back the sample followed by buffer along the sensor surface including the diffusion region that separates the sample and the running buffer;
xviii. contacting the sensor surface with the buffer while the sample is back in the cuvette and can be removed via the 1. drain line or 2. injection line.
xix. measuring the change in the surface plasmon resonance angle of light incidence at the sensor surface while in contact with the buffer being in back and forth movement so called dissociation phase;
xx. optionally washing the sensor surface with a regeneration liquid to regenerate the sensor surface; and
xxi. measuring a refractive index controlled buffer solution for calibrating the sensor by injecting a calibration liquid from the cuvette.
   The cuvette-injection-flow device to determine kinetic parameters using a ligand density gradient.

The cuvette-injection-flow device is the core of the invention and it enables also to generate a steep gradient of ligand density on the sensor surface. This has a huge advantage for measuring affinity parameters, because the value of the affinity constants (k_{d}, k_{d}, and K_{D}) that are determined by label free interaction analysis methods are affected by the ligand density. By creating a gradient in ligand densities an SPR imager using the cuvette-injection-flow device of the invention can measure the analyte ligand binding in a spatially resolved manner on the gradient of ligand density. A kinetic titration experiment which can be performed automatically in the cuvette flow cell without a regeneration step can be applied for various coupled antibodies in a gradient ligand density binding to a single antigen.

Globally fitted rate (k_{d} and kₐ) and dissociation equilibrium (K_{D}) constants for various ligand densities and analyte concentrations can be measured and parameters can be determined at a fixed ligand density (better a fixed Rₘₐₓ value) e.g. at Rₘₐₓ=100 uRIU response level (K_{D}^{R100}) or extrapolation can be carried out to Rₘₐₓ=0 μRIU.

These molecular binding constants that are derived from current, immobilized ligand based assays are affected by the immobilized state of the ligand. This causes the thus determined, apparent constants to deviate from the true “solution” constants due to interfering effects that result from the immobilization of the ligand. These interfering effects include rebinding effects, mass transport limitation, non-specific binding and deviation from the 1:1 model binding. The higher the ligand density, the more pronounced these interfering effects become and it is generally accepted that the ligand density should be applied just above the limit of detection of the biosensor instrument. The same holds for the analyte concentration-interfering effects will occur when multiple analyte molecules compete for interaction with a single immobilized ligand molecule.

So, the calculation of the “true” affinity equilibrium constant will become more reliable at lower densities, preferably at a “density” of only a single immobilized ligand molecule acting as a free ligand [1]. Then the contribution of the interfering effects will be zero and will no longer influence the rate- and affinity equilibrium constants. Practically, this condition cannot be measured and by decreasing the ligand density the more noisy and less reliable the sensorgrams become. Additionally the quality of fits to noisy curves cannot be judged adequately. It should be noted that immobilization artefacts and heterogeneity of surface binding sites should be prevented, for instance by oriented capturing of the ligands by applying high affinity anti-ligand antibodies or using tag-anti-tag interactions.

A so-called K_{D}^{R0} method for the determination of affinity constants has been published in 2011, in which the contribution of interfering effects is minimized or theoretically zeroed, so that the constants are a better estimate of the true constants of bio-molecular interactions in solution. This method is based on the extrapolation of the number of immobilized ligand and analyte molecules to zero, thus mimicking the interaction in which only one ligand and one analyte molecule are involved, enabling a true 1:1 binding model with theoretically not any interfering effect.

Recognized practical effects are additional ligand immobilization artefacts and heterogeneity of surface binding sites. The method will not compensate for this and the alternative route is by capturing ligands followed by the target interaction. When a harsh regeneration step is included the Rₘₐₓ value will decrease after the subsequent injections of the analyte concentrations and can again affect the kinetic affinity constants. Preferably any regeneration step of the surface should be avoided and this is achieved using kinetic titration.

Calculation of the kinetic constants was from spots with discrete ligand densities. Nowadays many users of SPR platforms are tuning the ligand density in such a way that the interaction with the analyte is at very low but still measurable values. The sensitivity of the instrument determines how low the ligand density can be. A user determines what he thinks is a low value and the values that users are creating are deviating from each other because there is no rule to interpret the quality of fitting of the binding curves.

The cuvette-injection-flow device enables the creation of a steep gradient of ligand density and the instrument measures the analyte binding on the ligand gradient. All densities are available from very high to zero low. So if the gradient in the flow cell is divided into e.g. 1000 Regions of Interest or better a tunable or dynamic Region of interest then the instrument can automatically find the binding result at e.g. Rₘₐₓ=100 μRIU or any value for a similar set of biomolecular interactions. The proven method as published by ref 1 and ref 2 can now be performed on a gradient ligand density instead of on a discrete low ligand density but on a limited number of spots. The interpretation of fitting quality by a user e.g. by applying a 1:1 Langmuir binding algorithm is not necessary anymore. The software generates the biomolecular affinity parameters measured always in the same way using the same ligand density at a location somewhere on the gradient. Interpretation of curves by a user, lab technician or operator of the instrument is not necessary anymore. Always the parameters are generated in the same way with the dynamic gradient method which is a huge improvement in analysis of the data.

There are many more applications when a controlled gradient of ligand density can be created on the sensor surface. E.g. particles like cells, viruses, organelles, vesicles etcetera contain a certain number of cell surface receptors (CD's) that bind to anti-CD antibodies. These antibodies will bind these particles and tests like an inhibition test can be performed on the gradient. The higher the affinity (better is avidity for multivalent interactions) of binding the better these particles will be present at low ligand densities. At ligand density zero it will not bind.

The T/S measurement strategy published in the Handbook of Surface Plasmon Resonance 2^{nd} edition chapter 12.8.1. page 447 can now be applied on a gradient. This could be an important strategy for avidity ranking of the interactions using the increased flow protocol as described in chapter 12.8.4. page 463. These detection strategies could be better applied to the sensor surface with a gradient of the ligand density.

Cells will bind to the sensor surface after injecting cells in a flow cell. Companies who are developing antibodies for various cell-applications need to characterize the affinity of monoclonal antibodies against living cell receptors. Direct detection of the antibody that binds to a sedimented cell line was not possible because of highly unstable baselines due to activity of the cells. However we found that the release of cells from the sensor surface depends on several factors. E.g. the flow velocity, the number of receptors on the cell, the affinity of the cell receptor to immobilized ligand, the ligand density etc. are important parameters. When a ligand gradient is applied in combination with increasing flow rates (shear rate) then ranking the affinity could possibly be measured on multiple receptor-Ab combinations. The shear on cells depends on the local velocity profile of the buffer stream on the immobilized cells. At a certain area on the ligand gradient the cells will still bind but by increasing the buffer velocity that drag the cells from the surface the cells will not bind anymore. The higher the velocity the higher the ligand density is needed to keep the cells on the surface. With SPR imaging this process can be followed in real time. By addressing a uniform force on the cells, a ligand density series of anti-membrane antigens will tune the position where cells at a certain velocity will dissociate from the gradient. In this way affinities of receptors on cells can be compared and ranked to each other when simultaneously different antibodies are immobilized in a ligand gradient. Then this SPRi-application will gain enormous impact.

A reliable and multi-functional SPR imaging measuring method is obtained when preferably the sensor surface comprises a plurality of active sites (e.g. spots or a gradient or gradient spots) monitored individually for change in the surface plasmon resonance angle of light incidence at the sensor surface, preferably with a camera.

In a special configuration of the CIF two small containers in the cuvette will be connected to a single flow cell in order to create two different ligand density gradients according to FIG. 8.

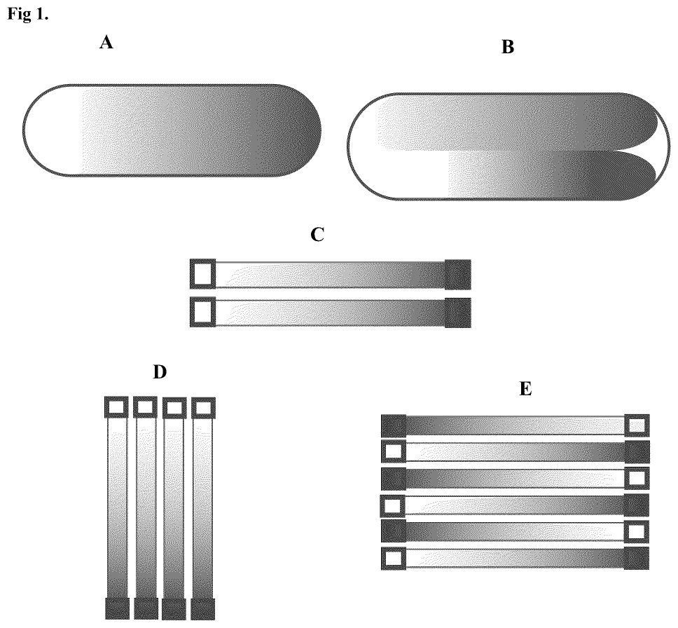

As shown in FIG. 1, the SPR measurement may be carried out in one single flow cell or in a plurality of flow cells e.g. 2 to 6 or more. When a plurality of flow cells is used, then each flow cell may be served by its own pump means for creating the ligand density in a gradient or without gradient on the sensor surface. However, it is preferred that the flow cell to inject the analyte is served by common pump means such that all spots are subjected to the same conditions (flow rate and transport and passage of sample, buffer therefore making it possible to do a reliable automatic measurement on the spots, gradient or gradiented spots. This is the so-called “one over all” method.

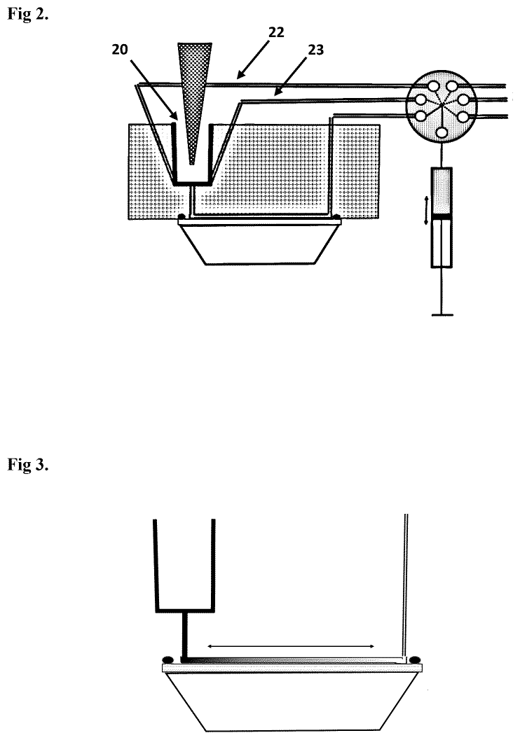

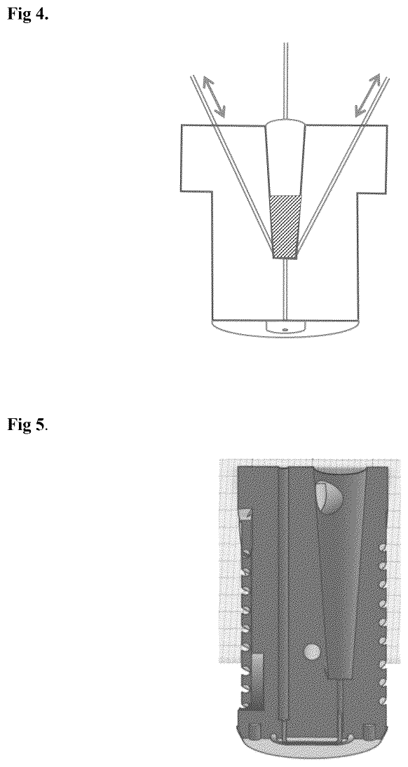

Mentioned and other features of the SPR measuring system and of the method for SPR measurement according to the invention will be further illustrated by various embodiments which are given for information purposes only and are not intended to limit the invention to any extent, while making reference to the annexed drawings, wherein FIG. 2. represents a schematic presentation of the cuvette injection flow system according to the invention; The cuvette, 20, is connected to an injection line, 22, and a drain line, 23. The cuvette is connected to the entrance of the flow cell by a low volume channel. The sample can be manually injected into the cuvette or by means of an autosampler. FIG. 3. Represents a larger scale detail of FIG. 2. The drawing is at the moment of injection including the ligand density gradient. FIG. 4. Shows the sample in the cuvette. The cuvette is operated with one or two injection or drain lines via distribution valves of the syringe pump. The cuvette is connected to the flow cell by means of a low volume channel. The outlet of the channel (in the back of the drawing) is connected to the syringe pump.

In order to avoid temperature effects, it is preferred that all liquids (sample, washing solution, calibration solution and the like) are subject to back and forth flow over the sensor surface. This can be accomplished by using the thermostated injection line as shown in FIG. 5. Clearly the cuvette is connected via the low volume channel to the flow cell and the outlet of the flow cell will be connected to the pump. The injection line of the cuvette will be twisted around the device in contact with the thermostated tubing for injecting thermostated sample into the cuvette.

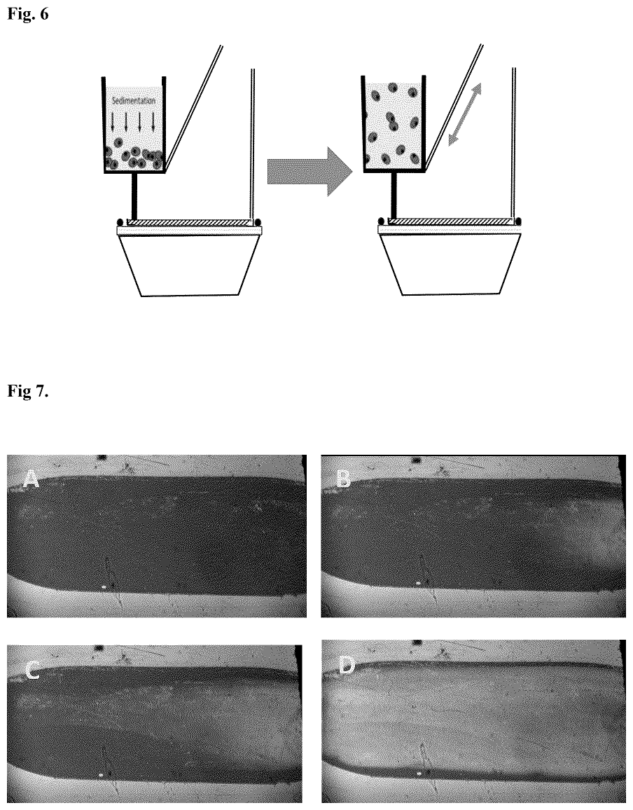

When injected into the cuvette, cells have the potential to sediment. FIG. 6. Depicts the steps to resuspend again with a back and forth flow. In order to get the cells in suspension again back and forth flow to the injection line can be applied. Then the cell suspension can be injected directly into the flow cell without delay. This way of mixing can also be applied to dilute the sample in the cuvette.

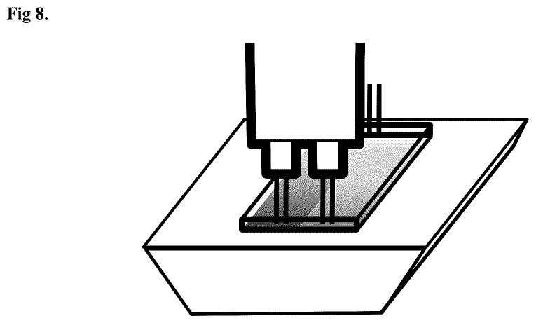

SPR images of the injection of the flow cell from the cuvette are shown in FIG. 7.

FIG. 8. Represents the cuvette designed with two additional containers on the bottom having two injection lines to the flow cell/chamber.

### The Analysis Cycle

As an example the process of operation of the cuvette injection flow system for SPR imagers is described. First, a base line measurement is carried out with the running buffer filling the flow cell and measuring the surface plasmon resonance angle of light incidence at the sensor surface with lapse of time by shining polarised light and monitoring the reflective light with the camera. (See FIG. 7, panel A). The measurement takes place according to the invention with the back and forth flow on. Subsequently the flow cell is filled first partly with sample by aspiration via the cuvette (See FIG. 7, panel B and panel C). In this way a gradient of ligand density can also be built.

When the sample fills the flow cell completely (FIG. 7, panel D), then SPR measurement takes place, again under back and forth flow. The volume of the sample is large enough to prevent in-diffusion of the running buffer into the sample during the measurement time of the sample. Thereafter, the sample is removed out of the flow cell and the flow cell is refilled with running buffer for carrying out the dissociation part of the SPR measurement for first measuring shift in the angle of light incidence due to a dissociation of non-specific compounds and subsequently the dissociation from the ligand bound target compounds. So the situation of FIG. 7, panel A is present, again under back and forth flow or even with back and forth flow with a continuous flushing of the flow cell with buffer.

Finally, the sample is removed from the system and the procedure for SPR measurement according to the invention may be restarted. Obviously, for calibration the sensor surface may be contacted with a calibration solution of which the shift of the surface plasmon resonance angle of light incidence at the sensor surface (and thus the refractive index) is known; such solution may be a water/glycerol mixture.

It is noted, although not yet described, that it is required to regenerate the active sites present in the flow cell after a sample measurement and the desorption measurement with buffer. Then a regeneration fluidum may be aspirated after for instance the release of the sample from the SPR measuring system, and subjecting the active sites to the regeneration medium, thereby providing the flow cell and its active sites in a regeneration form for measurement of target compounds considered. Injection of the regeneration liquid can be either via the cuvette by manual or autosampler means or operated via the tubing of flow cell port, injection line port or drain port. One of the tubing of the syringe pump should be connected to the regeneration liquid e.g. phosphoric acid 100 mM pH 3.0.

The cuvette supplied with two additional containers allows the creation of two different ligand density gradients on the sensor surface (see FIG. 8). Then the volume of each container with ligand should be similar to half the volume of the flow cell chamber. Both ligand density gradients can then be generated simultaneously by timely exposure of the ligands over the length of the flow cell that covers the activated sensor surface.

Although the present invention has been described with reference to specific embodiments, workers skilled in the art will recognize that many variations may be made therefrom, for example in the particular experimental conditions herein described, and it is to be understood and appreciated that the disclosures in accordance with the invention show only some preferred embodiments and objects and advantages of the invention without departing from the broader scope and spirit of the invention. It is to be understood and appreciated that these discoveries in accordance with this invention are only those which are illustrative of the many additional potential applications that may be envisioned by one of ordinary skill in the art, and thus are not in any way intended to be limiting of the invention. Accordingly, other objects and advantages of the invention will be apparent to those skilled in the art from the detailed description together with the claims.

### REFERENCES

1. R. B. M. Schasfoort, W. de Lau, A. van der Kooi, H. Clevers and Gerard H. M.
Engbers. Method for estimating the single molecular affinity, Anal. Biochem. 421 (2012), 794-796.
2. Schuck P. and Zhao H. The Role of Mass Transport Limitation and Surface Heterogeneity in the Biophysical Characterization of Macromolecular Binding Processes by SPR Biosensing. In Methods in Molecular Biology, Springer protocols. 627 (2010), 15-54.
3. Myszka D. G. et al. Extending the range of rate constants available from BIACORE: interpreting mass transport-influenced binding data. Biophys J. 75 (2) (1998): 583-94.
4. R. Karlsson, P. S. Katsamba, H. Nordin, E. Pol and D. G. Myszka, Analyzing a kinetic titration series using affinity biosensors. Anal. Biochem. 349 (2006) 136-147.

1. A Surface plasmon resonance measuring system comprising:
i. at least one sensor having a surface;
ii. at least one flow cell in liquid contact with the sensor surface;
iii. at least one cuvette as a microbioreactor connected to the entrance of the flow cell via a central channel;
iv. an optical unit for measuring the surface plasmon resonance reflection of light incidence at the sensor surface;
v. a liquid transport means via aspirating or dispensing; and
vi. a sampling means for supplying at least one sample from the open cuvette on top of the flow channel.

2. The System according to claim 1 wherein the channel between the cuvette to flow cell has a small sample volume applied to the cuvette.

3. The System according to claim 1 or claim 2 wherein the cuvette can be independently injected and/or drained without liquid transport in the flow cell.

4. The System according to claim 1 wherein the back and forth volume applied to the flow cell is less than the sample volume.

5. The System according to claim 1 where the cuvette can be emptied using at least a single drain connection without emptying the flow cell.

6. The System according to claim 1 where the cuvette can be injected with a sample manually using a pipette.

7. The System according to claim 1 where the cuvette can be injected with a sample automatically using an autosampler.

8. The System according to claim 1 where the injected sample in the cuvette can be transported by the liquid transport means to a drain or inject connection for storage of the sample.

9. The System according to claim 1 where the cuvette contains the flow cell to cuvette injection line, a drain line or a sample storage line.

10. The System according to claim 1 where the cuvette has two additional containers on the bottom with two injection lines to the flow cell/chamber.

11. The System according to claim 1 comprising more than one flow cells and cuvettes Surface plasmon resonance measuring systems.

12. The System according to claim 8 where a stored sample can be mixed with buffer injected via the flow cell for diluting the stored sample.

13. The System according to claim 12 where the stored sample is used for a kinetic titration experiment with an injection of at least 2 dilutions from the stored sample.

14. The System according to claim 8 where the sample is regeneration liquid or calibration liquid for automatic injection into the flow cell via the cuvette for regeneration or calibration.

15. The System according to claim 5 for injection of a suspension of particles or cells which are premixed in the cuvette by means of a syringe pump in back and forth flow via the injection or drain line.
